(19) United States
(12) Patent Application Publication
(10) Pub. No.: US 2009/0248986 A1
(43) Pub. Date: Oct. 1, 2009

(54) Apparatus for and Method of Implementing Multiple Content Based Data Caches

(76) Inventors: Daniel Citron, Haifa (IL); Moshe Klausner, Ramat Yishay (IL)

Correspondence Address: IBM CORPORATION, T.J. WATSON RESEARCH CENTER, P.O. BOX 218, YORKTOWN HEIGHTS, NY, 10598, US

(21) Appl. No.: 12/055,346

(22) Filed: Mar. 26, 2008

(51) Int. Cl. G06F 12/08

(52) U.S. Cl. 711/129; 711/E12.024; 711/E12.023

(57) ABSTRACT

A novel and useful mechanism enabling the partitioning of a normally shared L1 data cache into several different independent caches, wherein each cache is dedicated to a specific data type. To further optimize performance each individual L1 data cache is placed in relative close physical proximity to its associated register files and functional unit. By implementing separate independent L1 data caches, the content based data cache mechanism of the present invention increases the total size of the L1 data cache without increasing the time necessary to access data in the cache. Data compression and bus compaction techniques that are specific to a certain format can be applied each individual cache with greater efficiency since the data in each cache is of a uniform type.

### FIELD OF THE INVENTION

The present invention relates to the field of processor design and more particularly relates to a mechanism for implementing separate caches for different data types to increase cache performance.

### BACKGROUND OF THE INVENTION

The growing disparity of speed between the central processor unit (CPU) and memory outside the CPU chip is causing memory latency to become an increasing bottleneck in overall system performance. As CPU speed improves at a greater rate than memory speed improvements, CPUs are spend more time waiting for memory reads to complete.

The most popular solution to this memory latency problem is to employ some form of caching. Typically, a computer system has several levels of caches with the highest level L1 cache implemented within the processor core. The L1 cache is generally segregated into an instruction-cache (I-cache) and data cache (D-cache). These caches are implemented separately because the caches are accessed at different stages of the instruction pipeline and their contents have different characteristics.

A block diagram of a sample prior art implementation of CPU implementing an instruction cache and a Data cache is shown in FIG. 1. The central processing unit, generally referenced 10, comprises processor core 12 and L2 unified multiple data type cache 14. Processor core 12 is further comprised of instruction fetch (I-fetch) buffer 16, general purpose (GP) register file (RF) 18, floating point (FP) register file 20, vector register file 22, L1 instruction cache 26, and L1 multiple data type data cache (D-Cache) 26. In this implementation, L1 data cache 26 is coupled to general purpose register file 18, floating point register file 20 and vector register file 22. Calculations utilizing general purpose register file 18 are generally integer operations. The L2 unified cache 14 is a slower speed cache, located outside the processor core, and is a secondary cache to both L1 instruction cache 26 and L1 data cache 28.

As CPU designs advance, the L1 data cache is becoming too small to contain the flow of data needed by the processor. Aside from memory latency, access to the L1 data cache is also causing a bottleneck in the instruction pipeline, increasing the time between the effective address (EA) computation and L1 data cache access. In addition, new CPU designs implementing out of order (OOO) instruction processing and simultaneous multi-threading (SMT) require the implementation of a greater number of read/write ports in L1 data cache designs, which adds latency, takes up more space and uses more energy.

Current approaches to increase the performance of L1 data cache include (1) enlarging the L1 data cache; (2) compressing data in the L1 data cache, (3) using L1 data cache banking and (4) adding additional read/write ports to the L1 data. Each of these current solutions has significant drawbacks: Enlarging the L1 data cache increases the time necessary to access cache data. This is a significant drawback since L1 data cache data needs to be accessed as quickly as possible.

Compressing data in the L1 data cache enables the cache to store more data without enlarging the cache. The drawback to compression is that compression algorithms are generally optimal when compressing data of the same type. Since the L1 data cache can contain a combination of integer, floating point and vector data, compression results in low and uneven compression rates. While L1data chache banking segments a larger L1 data cache into smaller memory banks, determining the correct bank to access is in the critical path and adds additional L1 data cache access time.

Adding additional read/write ports to L1 data cache designs is also not an optimal solution—since these ports will increases the die size, consume more energy and increase latency. Finally, moving the L1 data cache closer to the MMU will result in the L1 data cache being farther away from other functional units (FU) such as the arithmetic logic unit (ALU) and floating point unit (FPU).

Therefore, there is a need for a mechanism to improve performance of L1 data caches by increasing the L1 data cache size without adding additional access time or the number of read/write ports. The mechanism should work with any data type and enable efficient compression of the various data types stored in an L1 data cache.

### SUMMARY OF THE INVENTION

The present invention provides a solution to the prior art problems discussed hereinabove by partitioning the L1 data cache into several different caches, with each cache dedicated to a specific data type. To further optimize performance, each individual L1 data cache is physically located close to its associated register files and functional unit. This reduces wire delay and reduces the need for signal repeaters.

By implementing separate L1 data caches, the content based data cache mechanism of the present invention increases the total size of the L1 data cache without increasing the time necessary to access data in the cache. Data compression and bus compaction techniques that are specific to a certain format can be applied each individual cache with greater efficiency since the data in each cache is of a uniform type (e.g., integer or floating point).

The invention is operative to facilitate the design of central processing units that implementing separate bus expanders to couple each L1 data cache to the L2 unified cache. Since each L1 cache is dedicated to a specific data type, each bus expander is implemented with a bus compaction algorithm optimized to the associated L1 data cache data type. Bus compaction reduces the number of physical wires necessary to couple each L1 data cache to the L2 unified cache. The resulting coupling wires can be thicker (i.e. than the wires that would be implemented in a design not implementing bus compaction), thereby further increasing data transfer speed between the L1 and L2 caches.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded L1 NUX, etc. or non-real time operating system such as Windows, UNIX, L1 NUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of implementing a plurality of content based data caches in a central processing unit, the method comprising the steps of determining the data type used by each functional unit of said central processing unit and implementing a separate data cache for each said data type on said central processing unit.

There is also provided in accordance with the invention, a method of implementing a plurality of content based data caches in close proximity to its associated functional unit in a central processing unit, the method comprising the steps of determining the data type used by each functional unit of said central processing unit, designing a separate data cache for each said data type on said central processing unit and implementing each said data cache in relative close physical proximity to each said functional unit associated with said data type.

There is further provided in accordance with the invention, a central processing unit system with a plurality of content based data caches, the system comprising a plurality of functional units and a separate data cache for each said functional unit of said central processing unit system.

### BRIEF DESCRIPTION OF THE DRAWINGS

The invention is herein described, by way of example only, with reference to the accompanying drawings, wherein:

FIG. 1 is a diagram of an example prior art implementation of a central processing unit implementing one L1 data cache;

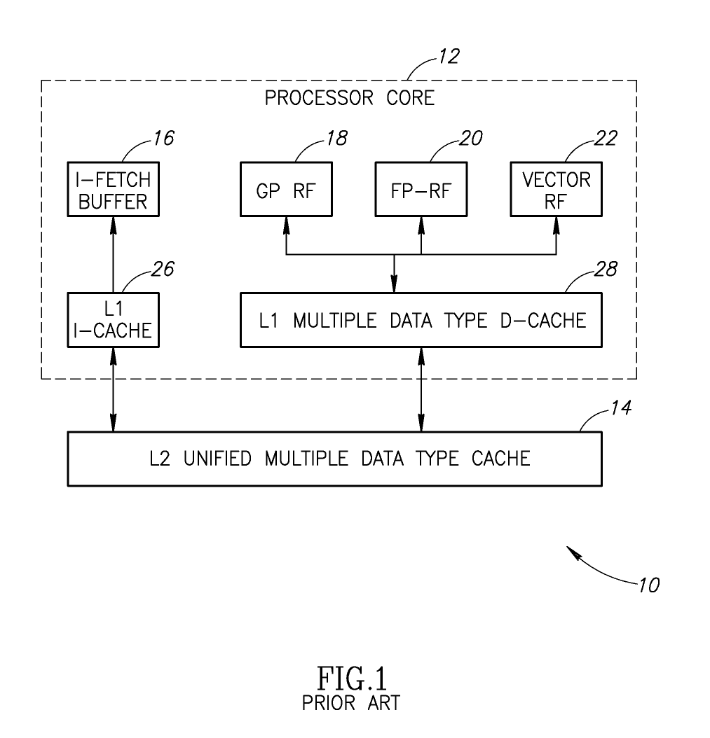

FIG. 2 is a diagram of a central processing unit implementing the content based data cache mechanism of the present invention;

FIG. 3 is a diagram illustrating L1 data cache affinity using the content based cache mechanism of the present invention;

FIG. 4 is a diagram illustrating bus compaction using the content based cache mechanism of the present invention;

FIG. 5 is a flow diagram illustrating the content based cache instruction processing mechanism of the present invention; and

FIG. 6 is a flow diagram illustrating the content based cache access method of the present invention.

### DETAILED DESCRIPTION OF THE INVENTION

### Notation Used Throughout

The following notation is used throughtout this document:

| Term | Definition |
|---|---|
| ALU | Arithmetic Logic Unit |
| CPU | Central Processing Unit |
| D-Cache | Data Cache |
| EA | Effective Address |
| FP | Floating Point |
| FPU | Floating Point Unit |
| FU | Functional Unit |
| GP | General Purpose |
| I-Cache | Instruction Cache |
| I-Fetch | Instruction Fetch Buffer |
| Int-Cache | Integer Cache |
| LD | Load |
| LSB | Least Significant Bit |
| MMU | Memory Management Unit |
| MSB | Most Significant Bit |
| OOO | Out Of Order |
| RF | Register File |
| SMT | Simultaneous Multi Threading |
| ST | Store |
| V-Cache | Vector Cache |

### DETAILED DESCRIPTION OF THE INVENTION

The present invention provides a solution to the prior art problems discussed hereinabove by partitioning the L1 data cache into several different caches, with each cache dedicated to a specific data type. To further optimize performance, each individual L1 data cache is physically located close to its associated register files and functional unit. This reduces wire delay and reduces the need for signal repeaters.

By implementing seperate L1 data caches, the content based data cache mechanism of the present invention increases the total size of the L1 data cache without increasing the time necessary to access data in the cache. Data compression and bus compaction techniques that are specific to a certain format can be applied each individual cache with greater efficiency since the data in each cache is of a uniform type (e.g., integer or floating point).

The invention is operative to facilitate the design of central processing units that implementing separate bus expanders to couple each L1 data cache to the L2 unified cache. Since each L1 cache is dedicated to a specific data type, each bus expander is implemented with a bus compaction algorithm optimized to the associated L1 data cache data type. Bus compaction reduces the number of physical wires necessary to couple each L1 data cache to the L2 unified cache. The resulting coupling wires can be thicker (i.e. than the wires that would be implemented in a design not implementing bus compaction), thereby further increasing data transfer speed between the L1 and L2 caches.

### Content Based Data Cache Mechanism

In accordance with the invention, cache segregation is based on the data type being referenced by an instruction executed by the central processing unit. During the decode stage of instruction execution, both the type of instruction and data type referenced are determined. If the instruction is a load (LD) or store (ST) then the data type is passed to the memory management unit (MMU). After the effective address (EA) of the data (i.e. in the cache) is computed the relevant cache (e.g., integer, floating point) is accessed.

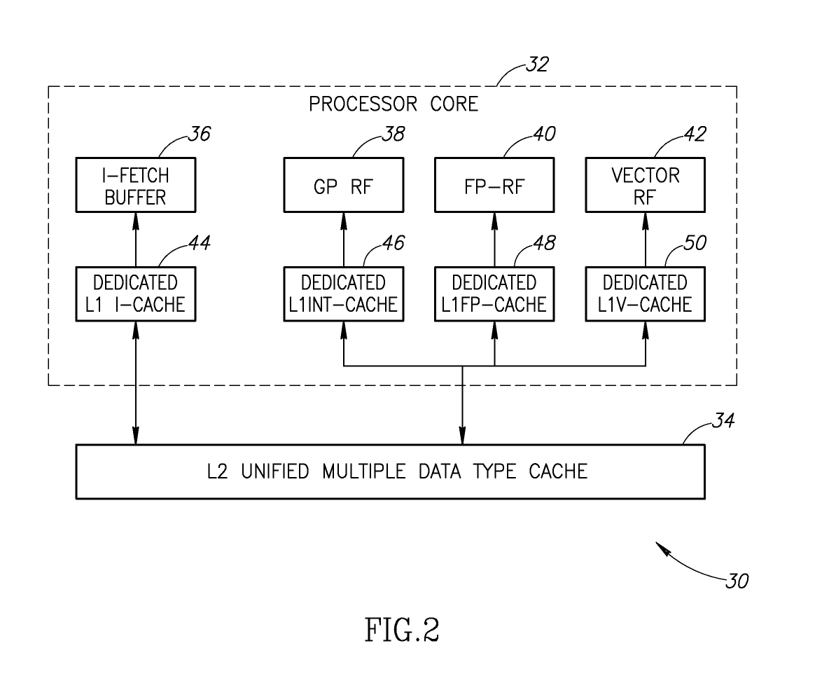

A block diagram illustrating a sample implementation of the content based data cache mechanism of the present invention is shown in FIG. 2. The central processing unit, generally referenced 50, comprises processor core 32 and L2 unified multiple data type cache 34. Processor core 32 is further comprised of instruction fetch buffer 36, general purpose register file 38, floating point register file 40, vector register file 42, dedicated L1 instruction cache 44, dedicated L1 integer cache 46, dedicated L1 floating point cache 48 and dedicated L1 vector cache 50. In this implementation, general purpose register file 38 is coupled to dedicated L1 integer cache 46, floating point register file 40 is coupled to dedicated L1 floating point cache 48 and vector register file 42 is coupled to dedicated L1 vector cache 50. L1 caches 44, 46, 48 and 50 are also coupled to L2 unified multiple data type cache 34.

There are several advantages to the content based data cache mechanism of the present invention, as described below. A first advantage is the implementation of a larger overall L1 data cache size by segregating the cache into separate data caches. By setting each individual cache size to the original size of the L1 data cache (i.e. a L1 single data cache in the prior art) increases the total L1 data cache size. The content based data cache access method of the present invention determines which cache to access as early as the decode stage (of instruction execution), therefore enabling enlarging the overall cache size without adding latency.

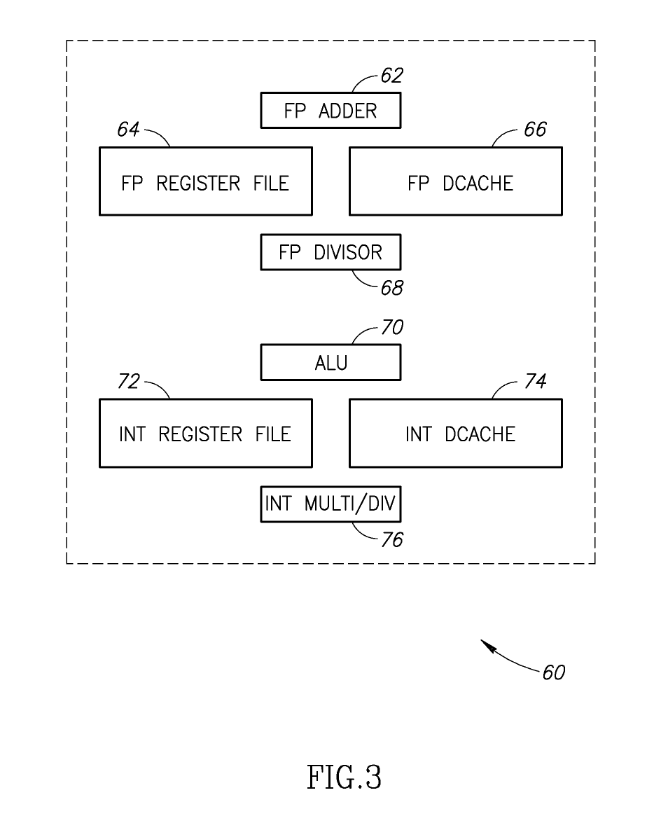

A second advantage to the content based data cache mechanism of the present invention is a faster L1 data cache access time due to cache affinity. Implementing a content based cache in close proximity to the register file and functional unit that processes the data stored in the cache (e.g., ALU or FPU) reduces both wire delays and the need for signal repeaters. A block diagram illustrating a sample embodiment of the cache affinity aspect of the present invention is shown in FIG. 3. The processor core portion, generally referenced 60, comprises floating point adder 62, floating point register file 64, floating point data cache 66, floating point divisor 68, arithmetic logic unit 70, integer register file, 72, integer data cache 74 and integer multiplier and divisor 76.

In processor core 60, the floating point data cache is located in relative close proximity to floating point adder 62, floating point register file 64 and floating point divisor 6. Integer data cache 74 is located in close proximity to arithmetic logic unit 70, integer register file 72 and integer multiplier and divisor 76.

A third advantage to the content based data cache mechanism of the present invention is the implementation of simpler load/store queues for the L1 data caches. Since load and store instructions are accessing different L1 data caches (based on the data type referenced by the instruction), smaller load/store queues for each L1 data cache can be implemented (i.e. compared to the monolithic load/store queue of the prior art).

A fourth advantage to the content based data cache mechanism of the present invention is efficient compression of L1 data cache data. Different compression algorithms can be implemented for different caches based on the data contained in each cache.

Narrow width detection is a compression algorithm for data where the most significant bits (MSBs) are all only zeros or ones. Therefore only the least significant bits (LSBs) are stored. While narrow width detection is a compression algorithm optimal for integer data, it is not suitable for compressing floating point data (Brooks and Martonesi, Dynamically Exploiting Narrow Width Operands to Improve Processor Power, HPCA-5, 1999, incorporated herein by reference).

Frequent value detection is an efficient compression algorithm for values that are used frequently (e.g., 0, 1, −1) and are therefore marked by a very small number of bits. The content based data cache mechanism of the present invention enables a more effective implementation of frequent value detection since a floating point 1 is stored differently than an integer 1. In addition, values such as Inf, −Inf, and NaN are unique to floating point data (Youtao Zhang and Jun Yang and Rajiv Gupta, Frequent value locality and value-centric data cache design, ASPLOS 9, 2000).

Duplication of data is a compression algorithm used when the data value in a word is duplicated along adjacent words. The algorithm identifies the duplication and marks the data duplication in the cache. The content based data cache mechanism of the present invention enables a more effective implementation duplication of data since the algorithm is more suitable for vector data as opposed to either floating point or integer data. Thus, different schemes can be used for the different caches, enabling better compaction rates for each cache.

A fifth advantage of the content based data cache mechanism of the present invention is bus compaction. Bus compaction is a method of using fewer wires (i.e. than the word size) to connect two busses. Since the optimal bus compaction algorithm differs by data type (e.g. integer, floating point), the content based data cache mechanism of the present invention enables the optimal compaction of busses coupling each L1 data cache to the L2 unified cache. This reduces the problem of wire delay that is prevalent in modern micro-processors. By segregating the data by type, each bus coupling an L1 data cache to the L2 unified cache can be implemented with a different width (i.e. number of wires coupling the buses).

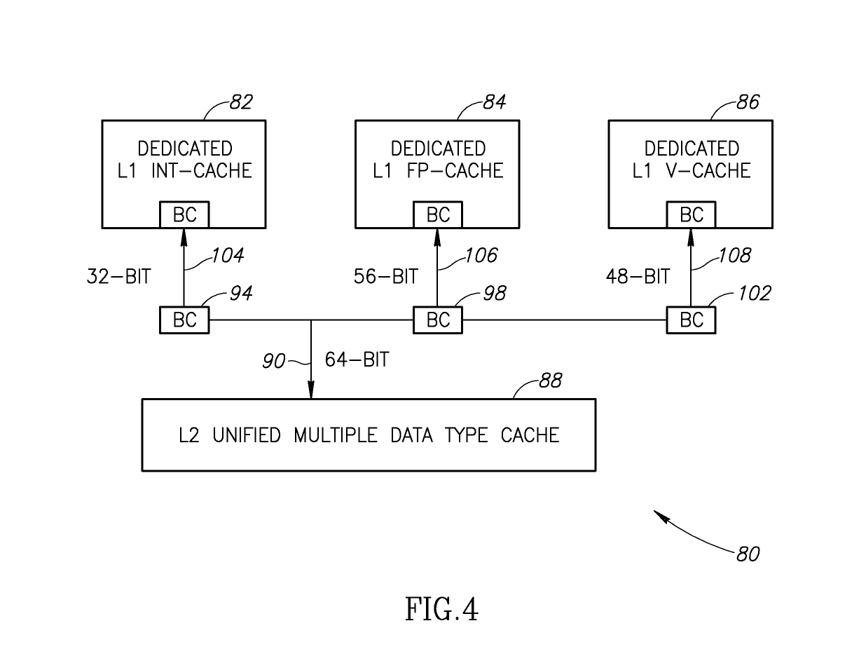

A block diagram illustrating a sample implementation of bus compaction for the content based data cache mechanism of the present invention is shown in FIG. 4. The cache system, generally referenced 80 comprises dedicated L1 integer cache 82, dedicated L1 floating point cache 84, dedicated L1 vector cache 86, L2 unified multiple data type cache 88, 64 bit bus 90, bus compactors 92, 94, 96, 98, 1000, 102, 32 bit bus 104, 56 bit bus 106 and 48 bit bus 108. In this implementation, caches 82, 84, 86, 88 have a 64 bit word size. While L2 cache 88 receives and sends data via 64 bit bus 90, bus compaction enables L1 data caches 82, 84, 88 to implement different algorithms optimized to the type of data stored in their respective caches. In this implementation, dedicated L1 integer data cache 82 couples to 64 bit bus 90 via 32 bit bus 104 using bus compactors 92 and 94. Dedicated L1 floating point cache 84 couples to 64 bit bus 90 via 56 bit bus 106 using bus compactors 96 and 98. Dedicated L1 vector cache 86 couples to 64 bit bus 90 via 48 bit bus 108 using bus compactors 92 and 100.

A sixth advantage the content based data cache mechanism of the present invention is cache configuration. Each separate content based data cache can be configured optimally for the type of data stored in the cache. L1 integer data caches can have a smaller block size than a L1 floating point data caches and L1 Vector data caches can have a smaller cache associativity.

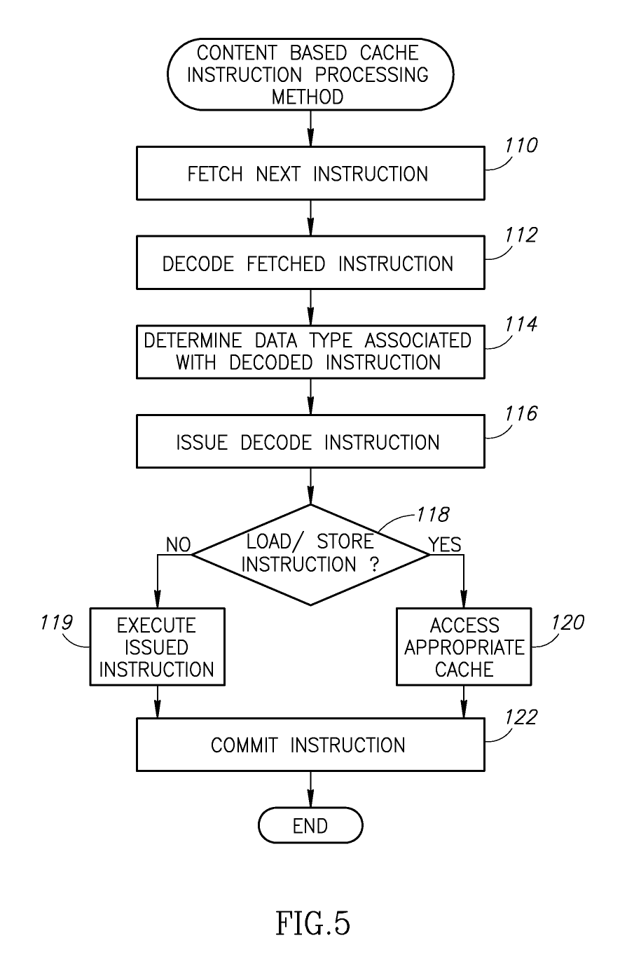

A flow diagram illustrating the instruction processing method of the present invention is shown in FIG. 5. First the next instruction is fetched (step 110). The instruction is decoded (step 112), the data type associated with the instruction is determined (step 114) and the instruction is then issued (step 116). If the instruction is a load or store (step 118) then the appropriate cache is accessed (step 120) (via the content based cache access method of the present invention) and the instruction is committed (step 122). If the instruction is not a load or store (step 118) then the issued instruction is executed (step 119) and committed (step 122).

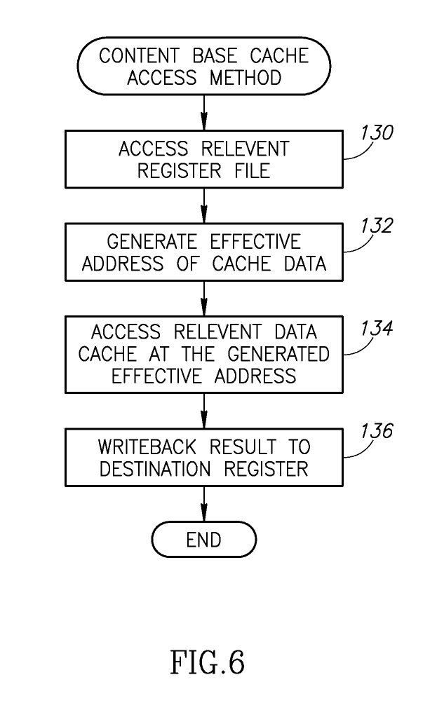

A flow diagram illustrating the content based cache access method of the present invention is shown in FIG. 6. First the relevant register file is accessed (step 130). The effective address of the cache data is generated (step 132) and the relevant content based data cache is accessed (step 134) at the generated effective address. Finally, the result is written back (i.e. writeback) to the destination register (step 136).

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling withing the spirit and scope of the invention.

What is claimed is:

1. A method of implementing a plurality of content based data caches in a central processing unit, said method comprising the steps of:
determining the data type used by each functional unit of said central processing unit; and
implementing a separate data cache for each said data type on said central processing unit.

2. The method according to claim 1, wherein said data type comprises integer.

3. The method according to claim 1, wherein said data type comprises floating point.

4. The method according to claim 1, wherein said data type comprises vector.

5. The method according to claim 1, wherein said functional unit comprises an arithmetic logic unit.

6. The method according to claim 1, wherein said functional unit comprises a floating point processing unit.

7. The method according to claim 1, wherein each said separate data cache is located in close proximity to its associated said functional unit.

8. A method of implementing a plurality of content based data caches in close proximity to its associated functional unit in a central processing unit, said method comprising the steps of:
determining the data type used by each functional unit of said central processing unit;
designing a separate data cache for each said data type on said central processing unit; and
implementing each said data cache in relative close physical proximity to each said functional unit associated with said data type.

9. The method according to claim 9, wherein said data type comprises integer.

10. The method according to claim 9, wherein said data type comprises floating point.

11. The method according to claim 9, wherein said data type comprises vector.

12. The method according to claim 9, wherein said functional unit comprises an arithmetic logic unit.

13. The method according to claim 9, wherein said functional unit comprises a floating point processing unit.

14. A central processing unit system with a plurality of content based data caches comprising:
a plurality of functional units; and
a separate data cache for each said functional unit of said central processing unit system.

15. The system according to claim 14, wherein said functional unit comprises an arithmetic logic unit.

16. The system according to claim 14, wherein said functional unit comprises a floating point processing unit.

17. The system according to claim 14, wherein said functional unit comprises a vector processing unit.

18. The system according to claim 14, wherein the type of data stored in each separate data cache and the data type for each said functional unit are identical.

19. The system according to claim 14, wherein each said separate data cache is located in close proximity to its associated functional unit.

20. The system according to claim 14, wherein each said content based data cache comprises an L1 data cache.
